(19) United States
(12) Patent Application Publication
(10) Pub. No.: US 2025/0186956 A1
(43) Pub. Date: Jun. 12, 2025

(54) HYDROGEN PRODUCTION SYSTEM

(71) Applicant: Industrial Technology Research Institute, Hsinchu (TW)

(72) Inventors: Hsu-Hsiang Cheng, Hsinchu City (TW); Chiu-Yen Chiu, Hsinchu City (TW)

(73) Assignee: Industrial Technology Research Institute, Hsinchu (TW)

(21) Appl. No.: 18/661,696

(22) Filed: May 12, 2024

(30) Foreign Application Priority Data
Dec. 7, 2023 (TW) 112147632

(51) Int. Cl. B01J 6/00; C01B 3/26

(52) U.S. Cl. CPC B01J 6/008; C01B 3/26; C01B 2203/0277; C01B 2203/049; C01B 2203/1241

(57) ABSTRACT

A hydrogen production system includes a hydrogen production reactor, a gas-solid separator, and a pressure-difference generating device. The hydrogen production reactor includes a first inlet, a reaction tank, and a first outlet. The hydrogen production reactor is configured to introduce a reaction gas to the reaction tank through the first inlet and perform a pyrolysis reaction in the reaction tank to generate a solid product and a gaseous product. The gas-solid separator is connected to the first outlet of the hydrogen production reactor to separate the solid product and the gaseous product generated by the pyrolysis reaction. The gas-solid separator includes a second inlet and a second outlet. The pressure-difference generating device is connected to the second outlet of the gas-solid separator and is configured to change a pressure at an outlet of the gas-solid separator to take the solid product away from the hydrogen production reactor.

### CROSS-REFERENCE TO RELATED APPLICATION

This application claims the priority benefit of Taiwan application serial no. 112147632, filed on Dec. 7, 2023. The entirety of the above-mentioned patent application is hereby incorporated by reference herein and made a part of specification.

### TECHNICAL FIELD

The disclosure relates to a hydrogen production system, and in particular to a pyrolysis hydrogen production system.

### BACKGROUND

Due to the large amount of carbon dioxide emissions generated for industrial demand, global warming is worsening. In order to reduce the use of fossil fuels to reduce carbon dioxide emissions, increasing the proportion of renewable energy and improving energy efficiency to maintain energy production for human needs are the goals and trends of research in various countries. Hydrogen energy is a secondary energy source that is abundant in nature and can be continuously recycled through regeneration and conversion. During the process of releasing energy, no greenhouse gases such as carbon dioxide are produced. Therefore, hydrogen energy has the advantages of low pollution and environmental protection and is regarded as a new energy source with great potential for development.

A pyrolysis method is used to decompose natural gas into carbon and hydrogen. Compared with the method for producing hydrogen by steam methane reforming, the pyrolysis method can reduce a large amount of carbon dioxide emissions, and compared with the method of producing hydrogen by electrolysis, the pyrolysis method can reduce energy consumption. However, carbon produced during the pyrolysis process for hydrogen production may continuously accumulate in the reactor and block the reactor, affecting the continuous operation of the process.

### SUMMARY

The hydrogen production system of the disclosure includes a hydrogen production reactor, a gas-solid separator, and a pressure-difference generating device. The hydrogen production reactor includes a first inlet, a reaction tank, and a first outlet. The hydrogen production reactor is configured to introduce a reaction gas to the reaction tank through the first inlet and perform a pyrolysis reaction in the reaction tank to generate a solid product and a gaseous product. The gas-solid separator is connected to the first outlet of the hydrogen production reactor to separate the solid product and the gaseous product generated by the pyrolysis reaction. The gas-solid separator includes a second inlet and a second outlet. The pressure-difference generating device is connected to the second outlet of the gas-solid separator. The pressure-difference generating device is configured to change a pressure at an outlet of the gas-solid separator to take the solid product in the hydrogen production reactor away from the hydrogen production reactor.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of a hydrogen production system according to an embodiment of the disclosure.

FIG. 2 is a schematic diagram of a hydrogen production system according to another embodiment of the disclosure.

FIG. 3 is a schematic diagram of a hydrogen production system according to another embodiment of the disclosure.

FIG. 4 is a schematic diagram of a hydrogen production system according to another embodiment of the disclosure.

### DETAILED DESCRIPTION

In the following, exemplary embodiments of the disclosure are comprehensively described with reference to the drawings, but the disclosure may also be implemented in various different forms and should not be construed as limited to the embodiments of the specification. In the drawings, for clarity, the size and thickness of each region, portion, and layer do not need to be shown to actual scale.

The directional terms mentioned in this disclosure, such as “up”, “down”, “front”, “back”, “left”, “right”, etc., are only for reference to the directions of the accompanying drawings. Accordingly, the directional terms used are illustrative and not limiting of the disclosure.

In the following embodiments, the same or similar components are marked by the same or similar reference numerals, and descriptions thereof will be omitted. In addition, the features of different exemplary embodiments may be combined with each other when they are not in conflict, and simple equivalent changes and modifications made according to the specification or the claims are still within the scope of the disclosure.

It should be understood that, even though terms such as “first”, “second”, “third”, etc., in the specification may be used herein to describe various components, members, regions, layers, and/or parts, these components, members, regions, and/or parts should not be limited by these terms. These terms are only used to distinguish one component, member, region, layer, or part from another component, member, region, layer, or part. Thus, a first component, member, region, layer, or part discussed below could be termed a second component, member, region, layer, or part without departing from the teachings herein.

The disclosure provides a hydrogen production system, which can effectively eliminate a solid product, so that hydrogen is continuously produced.

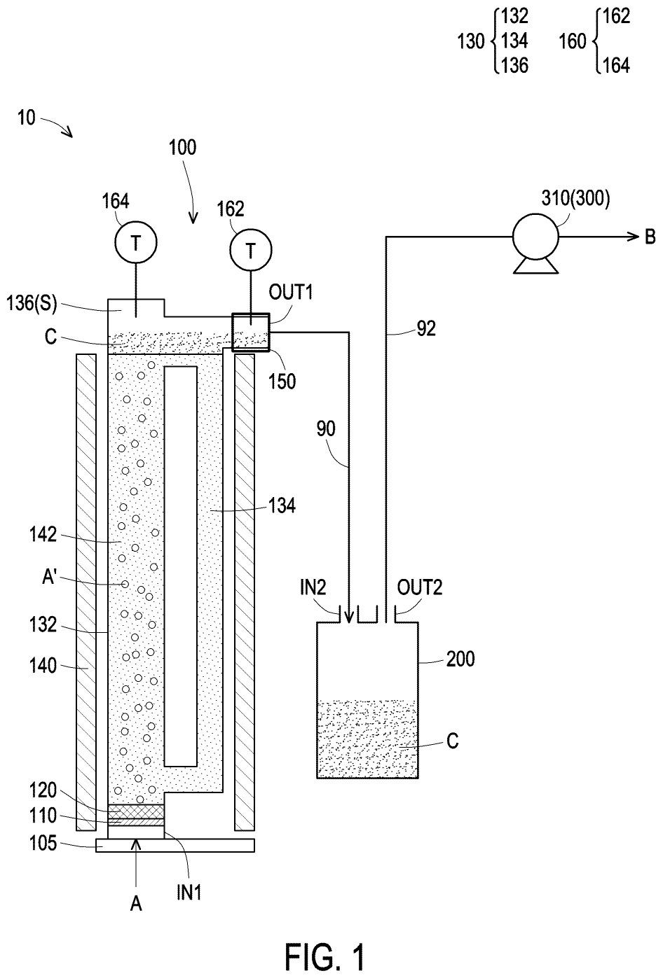

FIG. 1 is a schematic diagram of a hydrogen production system according to an embodiment of the disclosure.

Please refer to FIG. 1. A hydrogen production system 10 includes a hydrogen production reactor 100, a gas-solid separator 200, and a pressure-difference generating device 300. The hydrogen production reactor 100 includes a first inlet IN1, a reaction tank 130, and a first outlet OUT1, wherein the hydrogen production reactor 100 is configured to introduce a reaction gas A into the reaction tank 130 through the first inlet IN1 and perform a pyrolysis reaction in the reaction tank 130 to produce a solid product C and a gaseous product B. The gas-solid separator 200 is connected to the first outlet OUT1 of the hydrogen production reactor 100 to separate the solid product C and the gaseous product B generated by the pyrolysis reaction. The gas-solid separator 200 includes a second inlet IN2 and a second outlet OUT2. The pressure-difference generating device 300 is connected to the second outlet OUT2 of the gas-solid separator 200, wherein the pressure-difference generating device 300 is configured to change the pressure at the outlet of the gas-solid separator 200 to take the solid product C away from the hydrogen production reactor 100.

The reaction gas A includes hydrocarbons such as methane. The solid product C includes, for example, carbon. The gaseous product B includes, for example, hydrogen. In this disclosure, the pressure-difference generating device 300 refers to enabling the pressure difference (for example, the pressure difference between the first outlet OUT1 of the hydrogen production reactor 100 and the second outlet OUT2 of the gas-solid separator 200) of the hydrogen production system 10 to reach 0.01 atm or more through the device.

In some embodiments, the hydrogen production reactor 100 is, for example, a bubble column reactor. The reaction gas A enters the reaction tank 130 filled with liquid from bottom to top for reaction. Specifically, the first inlet IN1 of the hydrogen production reactor 100 is disposed at a lower part of the reaction tank 130, and the first outlet OUT1 is disposed at an upper part of the reaction tank 130. That is, the first inlet IN1 and the first outlet OUT1 are located on two opposite sides of the reaction tank 130. In some embodiments, the reaction tank 130 includes a liquid catalyst 142, and a top surface of the liquid catalyst 142 is lower than first outlet OUT1. The liquid catalyst 142 includes, for example, molten metal or molten salt. The molten metal includes, for example, nickel, tin, copper, bismuth, molybdenum, other suitable molten metals, or a combination thereof. The molten salt includes salts, such as sodium chloride and potassium chloride. Using the molten metal or the molten salt as a catalyst can lower a reaction temperature of the pyrolysis reaction and reduce energy consumption. In some embodiments, the reaction temperature of the pyrolysis reaction may be between 800° C. and 1175° C. The reaction gas A enters the reaction tank 130 from the lower part of the hydrogen generation reactor 100 via the first inlet IN1. The reaction gas A undergoes the pyrolysis reaction in the reaction tank 130 to generate the solid product C and the gaseous product B. Because of having a low density, the solid product C floats on a surface of the liquid catalyst 142 and continuously accumulates as the reaction proceeds, while the gaseous product B accumulates in an accommodation space S and flows out from the first outlet OUT1 with the pressure difference. In this way, the liquid catalyst 142 is less likely to be stuck and coated by the products, which can reduce the need for replenishing the catalyst, thereby reducing the manufacturing cost. In some embodiments, the reaction gas A may be unreacted or incompletely reacted in the reaction tank 130, and the unreacted reaction gas A and/or a gas by-product generated by the incomplete reaction may also accumulate in the accommodation space S with the gaseous product B and flow out from the first outlet OUT1 with the pressure difference.

In some embodiments, the reaction tank 130 has a first portion 132, a second portion 134, and a third portion 136. The first portion 132 and the second portion 134 are filled with the liquid catalyst 142. The pyrolysis reaction mainly occurs in the first portion 132. The second portion 134 is configured as a channel for a return flow of the liquid catalyst 142 and is connected to the upper part and the lower part of the first portion 132. The third portion 136 is located above the first portion 132 and the second portion 134 and is connected to the first outlet OUT1. The third portion 136 has the accommodation space S to accommodate the products generated by the pyrolysis reaction.

In some embodiments, the hydrogen production reactor 100 further includes a gas distributor 120 disposed near the first inlet IN1 of the hydrogen production reactor 100, so that after the reaction gas A passes through the gas distributor 120, many bubbles A′ are formed and enter the reaction tank 130 to be fully mixed with the liquid catalyst 142 in the reaction tank 130, and a contact area with the liquid catalyst 142 is increased, so that the reaction gas A may fully react in the reaction tank 130, thereby improving the conversion rate of the reaction.

In some embodiments, the gas distributor 120 is located between the first inlet IN1 and the first portion 132 of the reaction tank 130. That is, the gas distributor 120 overlaps the first portion 132 of the reaction tank 130. In some embodiments, the gas distributor 120 does not overlap the second portion 134 of the reaction tank 130. It can be seen that the reaction gas A mainly enters the first portion 132 of the reaction tank 130 after passing through the gas distributor 120 and drives the liquid catalyst 142 to flow from bottom to top. When the liquid catalyst 142 flows to a top part of the first portion 132, the liquid catalyst 142 may return to a bottom part of the first portion 132 through the second portion 134, and the solid product C and the gaseous product B generated by the pyrolysis reaction accumulate above the liquid catalyst 142 and in the third portion 136 due to lower densities than the density of the liquid catalyst 142.

In some embodiments, the hydrogen production reactor 100 further includes a porous support 110 disposed below the gas distributor 120 to provide support for the gas distributor 120 and initially disperse the reaction gas A.

In some embodiments, the hydrogen production reactor 100 further includes a heater 140 surrounding a side wall of the reaction tank 130 to heat the reaction tank 130, so that the reaction tank 130 reaches a required temperature for the reaction. In some embodiments, the heater 140 surrounds the first portion 132 and the second portion 134 of the reaction tank 130, but does not surround the third portion 136 of the reaction tank 130. That is, the temperature of the gaseous product B in the third portion 136 gradually decreases nearer to the first outlet OUT1.

In some embodiments, the hydrogen production reactor 100 further includes an isolation structure 105 disposed on the first inlet IN1 to be isolated from the external environment. The reaction gas A enters the reaction tank 130 from the first inlet IN1 through a hole (unillustrated) of the isolation structure 105. In some embodiments, the isolation structure 105 includes, for example, a ceramic material, but the disclosure is not limited thereto.

In some embodiments, the hydrogen production reactor 100 further includes a heat preservation device 150 disposed at the first outlet OUT1 of the hydrogen production reactor 100 to heat the gaseous product B near the first outlet OUT1 to increase the flow rate of the output of the gaseous product B, thereby driving the solid product C located in the third portion 136 of the reaction tank 130 away from the hydrogen production reactor 100, which contributes to the elimination of carbon. FIG. 1 only schematically illustrates a position of the heat preservation device 150, and for the sake of clarity, a perspective representation is used to schematically show that the first outlet IN1 covered by the heat preservation device 150 has the solid product C and the gaseous product B.

In some embodiments, the heat preservation device 150 is configured to maintain the temperature at the first outlet OUT1 between 200° C. and 600° C. In some embodiments, the heat preservation device 150 is configured to maintain the temperature at the first outlet OUT1 through a temperature control device 160. For example, one or more temperature sensors 162 may be installed near the first outlet OUT1 to measure the temperature, and then provide feedback to a controller (unillustrated) to adjust a setting temperature of the heat preservation device 150. In some embodiments, the temperature control device 160 may further include a temperature sensor 164 measuring the temperature of the gaseous product B disposed in the accommodation space S of the third portion 136 of the reaction tank 130.

In some embodiments, the hydrogen production system 10 further includes a first pipe line 90 connected between the first outlet OUT1 of the hydrogen production reactor 100 and the second inlet IN2 of the gas-solid separator 200, so that the solid product C and the gaseous product B may be transported to the gas-solid separator 200 from the hydrogen production reactor 100 via the first pipe line 90.

In some embodiments, the second inlet IN2 and the second outlet OUT2 of

the gas-solid separator 200 are both disposed on an upper part of the gas-solid separator 200. The solid product C is deposited in the gas-solid separator 200, and the gaseous product B may flow out from the second outlet OUT2, so that the solid product C and the gaseous product B may be simply separated. Moreover, the solid product C with high purity in the gas-solid separator 200 may be used as an industrial material and has high economic value.

In some embodiments, the hydrogen production system 10 further includes a second pipe line 92 connected to the second outlet OUT2 of the gas-solid separator 200, so that the gaseous product B may be outputted to, for example, a storage device or the next program (unillustrated) via the second pipe line 92.

In this embodiment, the pressure-difference generating device 300 includes a vacuum pump 310. The vacuum pump 310 is located on the second pipe line 92. When the vacuum pump 310 is activated, a large pressure difference may be generated in the hydrogen production system 10 to accelerate the flow of the gaseous product B, thereby driving the solid product C to take the solid product C in the hydrogen production reactor 100 away from the hydrogen production reactor 100, which can reduce the possibility of blockage caused by the solid product C continuously accumulated in the hydrogen production reactor 100. When the vacuum pump 310 stops, the gaseous product B may still be outputted through the second pipe line 92, but the solid product C accumulated in the hydrogen production reactor 100 is not easily taken away by the gaseous product B. That is, activating the vacuum pump 310 means performing a carbon removal operation on the hydrogen production reactor 100.

In some embodiments, the vacuum pump 310 is configured to operate intermittently or periodically. That is, the vacuum pump 310 does not operate continuously, but is activated after a period of time, and then shut down after being activated for a period of time. For example, the vacuum pump 310 may be configured to be activated according to an accumulated amount of the solid product C in the hydrogen production reactor 100. When the accumulated amount of the solid product C (for example, the height of the solid product C accumulated on the liquid catalyst 142) is greater than a setting value, the vacuum pump 310 is activated to perform the carbon removal operation. Moreover, the timing of stopping the vacuum pump 310 may be determined by the change amount of the solid product C in the gas-solid separator 200. For example, the vacuum pump 310 may be stopped when the height change of the solid product C accumulated in the gas-solid separator 200 slows down. In other embodiments, the vacuum pump 310 may be configured to be activated according to a fixed time period. The time period may be calculated to achieve a required time for a predetermined accumulated amount of the solid product C according to parameters such as the flow rate of the reaction gas A and the reaction rate of the pyrolysis reaction, and the time for each operation of the vacuum pump 310 may be set according to the rules of thumb.

Based on the above, a method for producing hydrogen gas by the hydrogen production system 10 is as follows. First, the reaction gas A undergoes the pyrolysis reaction through the hydrogen production reactor 100 to generate the solid product C and the gaseous product B. The pressure-difference generating device 300 reduces the pressure at the outlet of the gas-solid separator 200 through the vacuum pump 310, causing the system to generate a larger pressure difference to accelerate the flow of the gaseous product B, so that the gaseous product B entrains the solid product C to leave the hydrogen production reactor 100. Afterwards, the solid product C and the gaseous product B are separated via the gas-solid separator 200, so that the solid product C remains in the gas-solid separator 200, and the gaseous product B leaves the gas-solid separator 200 through the second pipe line 92. It may be seen that the hydrogen production system 10 may discharge the solid product C from the hydrogen production reactor 100 through the pressure-difference generating device 300, so that the reaction may continue to proceed, thereby increasing the yield.

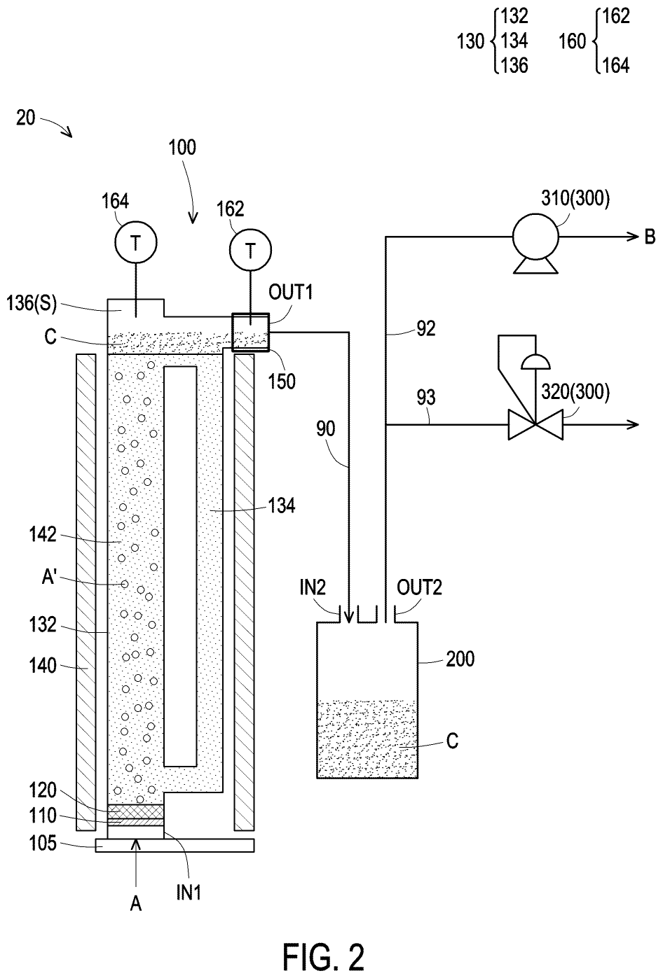

FIG. 2 is a schematic diagram of a hydrogen production system according to another embodiment of the disclosure. The embodiment of FIG. 2 continues to use the reference numerals and a part of the contents of the embodiment of FIG. 1, wherein the same or similar reference numerals are used to denote the same or similar components, and the description of the same technical content is omitted. For the description of the omitted part, reference may be made to the foregoing embodiment, and details are not described herein.

Please refer to FIG. 2. The difference between a hydrogen production system 20 in FIG. 2 and the hydrogen production system 10 in FIG. 1 lies in that: the pressure-difference generating device 300 of the hydrogen production system 20 further includes a back pressure valve 320. The back pressure valve 320 may be connected to the first pipe line 90 or the second pipe line 92 to increase the pressure of the hydrogen production system 20, so that when the vacuum pump 310 is activated, a larger pressure difference may be generated to drive the solid product C in the hydrogen production reactor 100 away from the hydrogen production reactor 100.

In some embodiments, the back pressure valve 320 may be connected to the second pipe line 92 through a branch line 93. In some embodiments, the back pressure valve 320 is connected to the second pipe line 92 before the vacuum pump 310.

In some embodiments, the pressure of the back pressure valve 320 may be set between 3 atm and 20 atm, so that the hydrogen production system 20 is maintained at a higher pressure. In this way, when the vacuum pump 310 is activated, a large pressure difference may be generated to drive the solid product C in the hydrogen production reactor 100 away from the hydrogen production reactor 100. In some embodiments, when the pressure of the back pressure valve 320 is greater than a setting value, a part of the gaseous product B may be discharged to the storage device (unillustrated) from the branch line 93.

The back pressure valve 320 is illustrated to be connected to the second pipe line 92 in FIG. 2, but is not intended to limit the disclosure. In other embodiments, the back pressure valve 320 may be connected to the first pipe line 90.

Based on the above, a method for producing hydrogen gas by the hydrogen production system 20 is as follows. First, the reaction gas A undergoes the pyrolysis reaction through the hydrogen production reactor 100 to generate the solid product C and the gaseous product B. The pressure-difference generating device 300 establishes the pressure of the system through the back pressure valve 320 and decreases the pressure at the outlet of the gas-solid separator 200 through the vacuum pump 310, causing the system to generate a larger pressure difference to accelerate the flow of the gaseous product B, so that the gaseous product B entrains the solid product C to leave the hydrogen production reactor 100. Afterwards, the solid product C and the gaseous product B are separated via the gas-solid separator 200, so that the solid product C remains in the gas-solid separator 200, and the gaseous product B leaves the gas-solid separator 200 through the second pipe line 92. It can be seen that the hydrogen production system 20 may discharge the solid product C from the hydrogen production reactor 100 through the pressure-difference generating device 300, so that the reaction may continue to proceed, thereby increasing the yield.

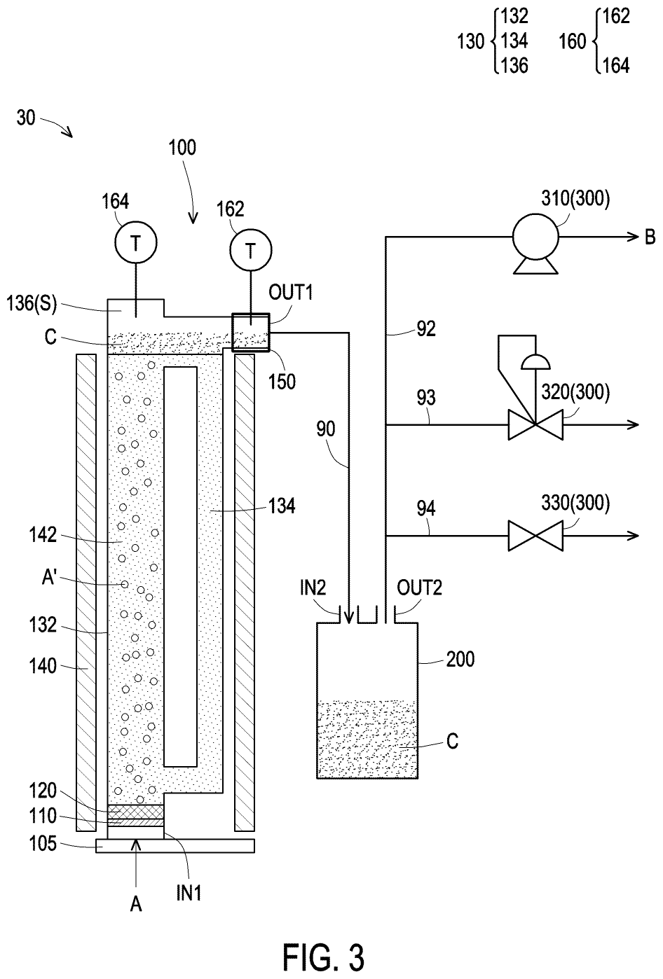

FIG. 3 is a schematic diagram of a hydrogen production system according to another embodiment of the disclosure. The embodiment of FIG. 3 continues to use the reference numerals and a part of the contents of the embodiment of FIG. 2, wherein the same or similar reference numerals are used to denote the same or similar components, and the description of the same technical content is omitted. For the description of the omitted part, reference may be made to the foregoing embodiment, and details are not described herein.

Please refer to FIG. 3. The difference between a hydrogen production system 30 in FIG. 3 and the hydrogen production system 20 in FIG. 2 lies in that: the pressure-difference generating device 300 of the hydrogen production system 30 further includes a pressure relief valve 330. The pressure relief valve 330 is connected to the second pipe line 92 to reduce the pressure at the outlet of the gas-solid separator 200, so that the system generates a large pressure difference to drive the solid product C in the hydrogen production reactor 100 away from the hydrogen production reactor 100.

In some embodiments, the pressure relief valve 330 may be connected to the second pipe line 92 through a branch line 94. When the pressure relief valve 330 is opened, a part of the gaseous product B may be discharged to the storage device (unillustrated) from the branch line 94. In some embodiments, the pressure relief valve 330 is connected to the second pipe line 92 before the back pressure valve 320 and the vacuum pump 310.

In the hydrogen production system 20, both the vacuum pump 310 and the pressure relief valve 330 may help discharge the solid product C in the hydrogen production reactor 100. In some embodiments, the hydrogen production system 30 may perform the carbon removal operation on the hydrogen production reactor 100 mainly by using the vacuum pump 310, and the pressure relief valve 330 may be used as an auxiliary. For example, the vacuum pump 310 may be configured to be activated according to the accumulated amount of the solid product C in the hydrogen production reactor 100 or a fixed period, and the pressure relief valve 330 may be configured to be opened when the pressure of the back pressure valve 320 reaches the setting value; and to be closed when the pressure of the back pressure valve 320 is less than the setting value.

Based on the above, the method for producing hydrogen gas by the hydrogen production system 30 is as follows. First, the reaction gas A undergoes the pyrolysis reaction through the hydrogen production reactor 100 to generate the solid product C and the gaseous product B. The pressure-difference generating device 300 establishes the pressure of the system through the back pressure valve 320 and reduces the pressure at the outlet of the gas-solid separator 200 through the vacuum pump 310 and/or the pressure relief valve 330, causing the hydrogen production system 30 to generate a large pressure difference to accelerate the flow of the gaseous product B, so that the gaseous product B entrains the solid product C to leave the hydrogen production reactor 100. Afterwards, the solid product C and the gaseous product B are separated via the gas-solid separator 200, so that the solid product C remains in the gas-solid separator 200, and the gaseous product B leaves the gas-solid separator 200 through the second pipe line 92. It can be seen that the hydrogen production system 30 may discharge the solid product C from the hydrogen production reactor 100 through the pressure-difference generating device 300, so that the reaction may continue to proceed, thereby increasing the yield.

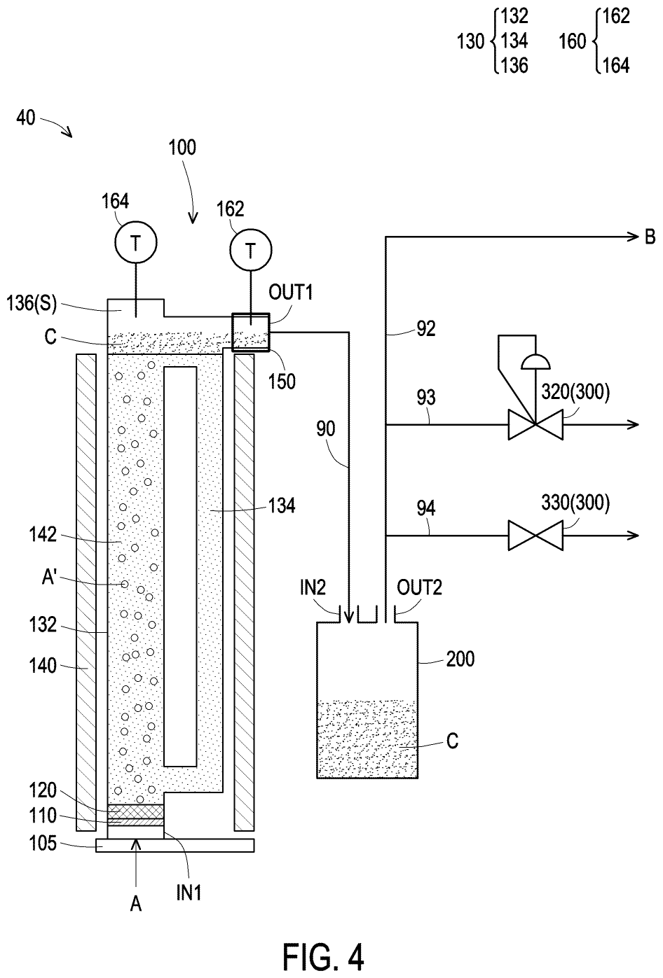

FIG. 4 is a schematic diagram of a hydrogen production system according to another embodiment of the disclosure. The embodiment of FIG. 4 continues to use the reference numerals and a part of the contents of the embodiment of FIG. 3, wherein the same or similar reference numerals are used to denote the same or similar components, and the description of the same technical content is omitted. For the description of the omitted part, reference may be made to the foregoing embodiment, and details are not described herein.

Please refer to FIG. 4. The difference between a hydrogen production system 40 in FIG. 4 and the hydrogen production system 30 in FIG. 3 lies in that: the pressure-difference generating device 300 of the hydrogen production system 40 includes the back pressure valve 320 and the pressure relief valve 330, but does not include the vacuum pump 310. In this way, the hydrogen production system 40 may perform the carbon removal operation on the hydrogen production reactor 100 by using the pressure relief valve 330, so that the reaction may continue to proceed. For example, the pressure relief valve 330 may be configured to be opened when the pressure of the back pressure valve 320 reaches the setting value (for example, 3 atm to 20 atm) to take the solid product C in the hydrogen production reactor 100 away from the hydrogen production reactor 100; and to be closed when the pressure of the back pressure valve 320 is less than the setting value.

Based on the above, the method for producing hydrogen gas by the hydrogen production system 40 is as follows. First, the reaction gas A undergoes the pyrolysis reaction through the hydrogen production reactor 100 to generate the solid product C and the gaseous product B. The pressure-difference generating device 300 establishes the pressure of the system through the back pressure valve 320 and reduces the pressure at the outlet of the gas-solid separator 200 through the pressure relief valve 330, causing the system to generate a larger pressure difference to accelerate the flow of the gaseous product B, so that the gaseous product B entrains the solid product C to leave the hydrogen production reactor 100. Afterwards, the solid product C and the gaseous product B are separated via the gas-solid separator 200, so that the solid product C remains in the gas-solid separator 200, and the gaseous product B leaves the gas-solid separator 200 through the second pipe line 92. It can be seen that the hydrogen production system 40 may discharge the solid product C from the hydrogen production reactor 100 through the pressure-difference generating device 300, so that the reaction may continue to proceed, thereby increasing the yield.

To sum up, the hydrogen production system of the disclosure includes the hydrogen production reactor, the gas-solid separator, and the pressure-difference generating device. By increasing the pressure difference of the hydrogen production system, the solid product generated in the reaction may be taken away from the hydrogen production reactor by the gaseous product to reduce the possibility of the blockage in the hydrogen production reactor by the solid product, so that the reaction may continue to proceed, thereby increasing the yield.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A hydrogen production system, comprising:
a hydrogen production reactor, comprising a first inlet, a reaction tank, and a first outlet, wherein the hydrogen production reactor is configured to introduce a reaction gas to the reaction tank through the first inlet and perform a pyrolysis reaction in the reaction tank to generate a solid product and a gaseous product;
a gas-solid separator, connected to the first outlet of the hydrogen production reactor to separate the solid product and the gaseous product generated by the pyrolysis reaction, wherein the gas-solid separator comprises a second inlet and a second outlet; and
a pressure-difference generating device, connected to the second outlet of the gas-solid separator, wherein the pressure-difference generating device is configured to change a pressure at an outlet of the gas-solid separator to take the solid in the hydrogen production reactor product away from the hydrogen production reactor.

2. The hydrogen production system according to claim 1, further comprising:
a first pipe line, connected between the first outlet of the hydrogen production reactor and the second inlet of the gas-solid separator, so that the solid product and the gaseous product are transported to the gas-solid separator from the hydrogen production reactor via the first pipe line; and
a second pipe line, connected to the second outlet of the gas-solid separator, so that the gaseous product is outputted.

3. The hydrogen production system according to claim 2, wherein the pressure-difference generating device comprises a vacuum pump, and the vacuum pump is located on the second pipe line.

4. The hydrogen production system according to claim 3, wherein the vacuum pump is configured to operate intermittently or periodically.

5. The hydrogen production system according to claim 3, wherein the vacuum pump is configured to be activated according to an accumulated amount of the solid product in the hydrogen production reactor to drive the solid product in the hydrogen production reactor away from the hydrogen production reactor.

6. The hydrogen production system according to claim 3, wherein the pressure-difference generating device further comprises a back pressure valve, and the back pressure valve is connected to the first pipe line or the second pipe line.

7. The hydrogen production system according to claim 6, wherein the pressure-difference generating device further comprises a pressure relief valve, and the pressure relief valve is connected to the second pipe line.

8. The hydrogen production system according to claim 2, wherein the pressure-difference generating device comprises:
a back pressure valve, connected to the first pipe line or the second pipe line; and
a pressure relief valve, connected to the second pipe line, wherein the pressure relief valve is configured to be opened when a pressure of the back pressure valve reaches between 3 atm and 20 atm to take the solid product in the hydrogen production reactor away from the hydrogen production reactor.

9. The hydrogen production system according to claim 1, further comprising:
a heat preservation device, disposed at the first outlet of the hydrogen production reactor.

10. The hydrogen production system according to claim 9, wherein the heat preservation device is configured to maintain a temperature at the first outlet between 200° C. and 600° C.

11. The hydrogen production system according to claim 1, wherein the reaction tank of the hydrogen production reactor comprises a liquid catalyst, and the liquid catalyst comprises molten metal or molten salt.

12. The hydrogen production system according to claim 11, wherein the hydrogen production reactor is configured to introduce the reaction gas to perform the pyrolysis reaction in the reaction tank from bottom to top through the liquid catalyst, and the solid product and the gaseous product generated by the pyrolysis reaction are located above the liquid catalyst.
